(19) United States
(12) Patent Application Publication
(10) Pub. No.: US 2002/0163265 A1
(43) Pub. Date: Nov. 7, 2002

(54) Miniature vibration motors structure

(75) Inventors: Alex Horng, Kaohsiung (TW); Ching-Shen Hong, Kaohsiung (TW); Tso-Kuo Yin, Kaohsiung Hsien (TW)

Correspondence Address: Bacon & Thomas, 4th Floor, 625 Slaters Lane, Alexandria, VA, 22314, US

(73) Assignee: Sunonwealth Electric Machine Industry Co., Ltd., Kaohsiung (TW)

(21) Appl. No.: 09/848,315

(22) Filed: May 4, 2001

(51) Int. Cl. H02K 7/06; H02P 3/00

(52) U.S. Cl. 310/81; 318/114; 310/156.08

(57) ABSTRACT

A miniature vibration motor structure includes a housing having a hole for receiving and positioning one end of a shaft whose other end is positioned in a fixing plate. A rotor includes a bearing integrally combined with an annular permanent magnet. The bearing of the rotor is supported and rotated on the shaft. The bearing or the annular permanent magnet is provided with a recess or protruding block, so that the center of gravity and the center of rotation of the rotor are not in concert with each other. A stator seat is wound with a coil and has a power inlet for supplying an electric power into the stator seat. The stator seat has poles which may be induced with the permanent magnet of the rotor.

### BACKGROUND OF THE INVENTION

1. Field of the Invention

The present invention primarily relates to a miniature vibration motor structure, and more particularly to a miniature vibration motor structure required with a smaller volume.

2. Description of the Related Art

A conventional miniature vibration motor structure in accordance with the prior art shown in FIG. 9 comprises an upper casing 90 and a lower casing 91 secured with each other. The upper casing 90 is provided with a seat 92 protruding upward, and the lower casing 91 is also provided with a seat 92 protruding downward. A bearing 93 is received in the seat 92. A central shaft 94 is pivoted with the upper and lower bearings 93. The central shaft 94 is fitted with a counterweight 95 that is combined with a rotor 96. The outer periphery of the rotor 96 has a permanent magnet 97 induced with a coil seat 98. The counterweight 95 of the rotor 96 is partially recessed to form a recess 99, so that vibration is generated during rotation of the rotor 96.

The conventional miniature vibration motor is usually available in the communication equipment, such as a calling machine, a mobile telephone (or cellular phone) or the like. The design of the communication equipment is required strictly to be light, thin, and small. However, in the construction of such a kind of conventional miniature vibration motor, the upper casing 90 is provided with a seat 92 protruding upward, and the lower casing 91 is also provided with a seat 92 protruding downward for receiving the bearing 93, while the outer side of the central shaft 94 is fitted with a counterweight 95. Thus, the conventional miniature vibration motor has multiple parts, thereby causing inconvenience in assembly, and relatively, the thickness and volume thereof cannot be reduced easily.

### SUMMARY OF THE INVENTION

The primary objective of the present invention is to provide a miniature vibration motor structure, wherein the miniature vibration motor has a simpler construction, and has a smaller volume and thickness.

In accordance with the present invention, there is provided a miniature vibration motor structure includes a housing having a hole for receiving and positioning one end of a shaft whose other end is positioned in a fixing plate. A rotor includes a bearing integrally combined with an annular permanent magnet. The bearing of the rotor is supported and rotated on the shaft. The bearing or the annular permanent magnet is provided with a recess or protruding block, so that the center of gravity and the center of rotation of the rotor are not in concert with each other. A stator seat is wound with a coil and has a power inlet for supplying an electric power into the stator seat. The stator seat has poles which may be induced with the permanent magnet of the rotor.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a miniature vibration motor structure in accordance with a first embodiment of the present invention;

FIG. 2 is a cross-sectional assembly view of the miniature vibration motor structure as shown in FIG. 1;

FIG. 3 is a cross-sectional assembly view of a miniature vibration motor structure in accordance with a second embodiment of the present invention;

FIG. 4 is a perspective view of a rotor of a miniature vibration motor structure in accordance with a third embodiment of the present invention;

FIG. 5 is a perspective view of a rotor of a miniature vibration motor structure in accordance with a fourth embodiment of the present invention;

FIG. 6 is a cross-sectional assembly view of the miniature vibration motor structure in accordance with the fourth embodiment of the present invention;

FIG. 7 is a cross-sectional assembly view of a miniature vibration motor structure in accordance with the fifth embodiment of the present invention;

FIG. 8 is a cross-sectional assembly view of a miniature vibration motor structure in accordance with the sixth embodiment of the present invention; and

FIG. 9 is a cross-sectional assembly view of a conventional miniature vibration motor structure in accordance with the prior art.

### DETAILED DESCRIPTION OF THE PREFERRED EMBODIMENTS

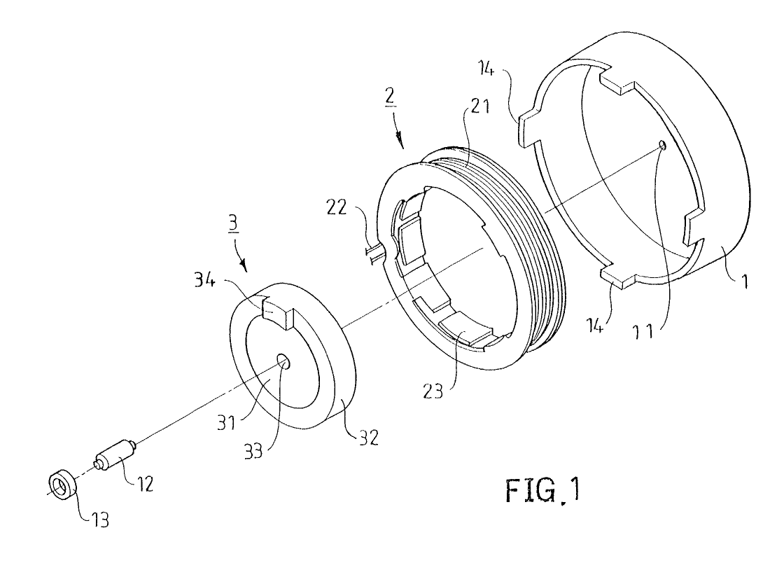

Referring to the drawings and initially to FIG. 1, a miniature vibration motor structure in accordance with a first embodiment of the present invention comprises a housing 1, a stator seat 2, and a rotor 3.

The housing 1 defines a hole 11 for receiving and positioning one end of a shaft 12 whose other end may be positioned in the base plate of a conventional communication equipment. The shaft 12 is fitted in the shaft hole 33 of the rotor 3, for supporting the rotor 3 to rotate in a positioning manner. A positioning ring 13 is rested on the rotor 3. The housing 1 has a periphery provided with protruding locking blocks 14, so that the housing 1 may be fixed on a fixing plate such as a circuit board or a base plate.

The stator seat 2 is wound with a coil 21, and has a power inlet 22 for supplying the electric power into the stator seat 2. The stator seat 2 has poles 23 which may be induced with the permanent magnet 32 of the rotor 3, to drive the rotor 3 to rotate.

The rotor 3 includes a bearing 31, and an annular permanent magnet 32 integrally formed on the outer periphery of the bearing 31. The center of the rotor 3 has a shaft hole 33 for passage of the shaft 12, so that the rotor 3 is supported by the shaft 12 to rotate. The permanent magnet 32 of the rotor 3 is induced with the poles 23 of the stator seat 2, so that the rotor 3 can be driven to rotate. In the preferred embodiment, the annular permanent magnet 32 on the periphery of the rotor 3 is provided with a protruding block 34, so that the center of gravity and the center of rotation of the rotor 3 are not at the same central line. Thus, the rotation of the rotor 3 will form an unbalanced vibration.

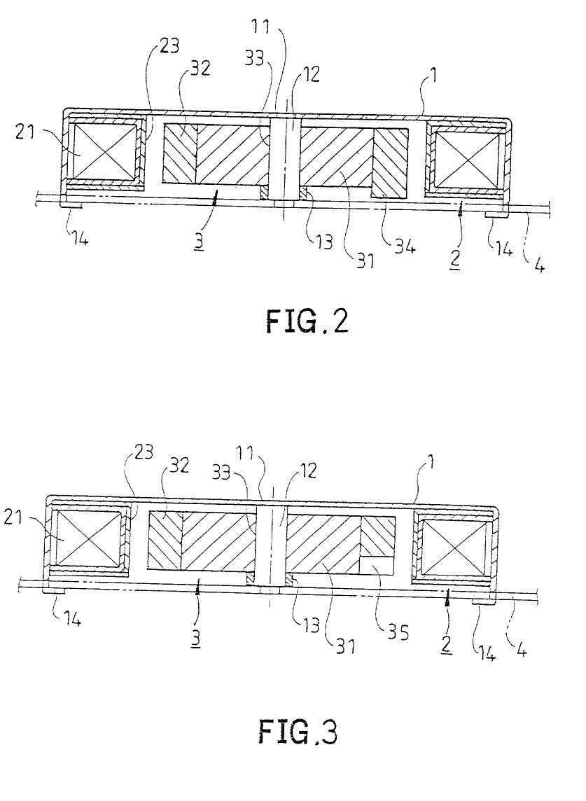

Referring to FIG. 2, the miniature vibration motor structure in accordance with the first embodiment of the present invention is assembled. The housing 1 is fixed on a fixing plate 4 such as a circuit board or a base plate. The locking blocks 14 of the housing 1 may be bent so that the housing 1 is fixed on the fixing plate 4. The two ends of the shaft 12 are respectively positioned in the hole 11 of the housing 1 and the fixing plate 4. The shaft 12 is passed through the shaft hole 33 of the rotor 3, for supporting the rotor 3 to rotate. Thus, when the permanent magnet 32 of the rotor 3 is induced with the poles 23 of the stator seat 2, the rotor 3 can be driven to rotate. In addition, the rotor 3 is provided with the protruding block 34, so that the center of gravity and the center of rotation of the rotor 3 are not at the same central line. Thus, the rotation of the rotor 3 will form an unbalanced vibration.

Referring to FIG. 3, in accordance with a second embodiment of the present invention, the annular permanent magnet 32 on the periphery of the rotor 3 is provided with a recess 35, so that the center of gravity and the center of rotation of the rotor 3 are not at the same central line. Thus, the rotation of the rotor 3 will form an unbalanced vibration.

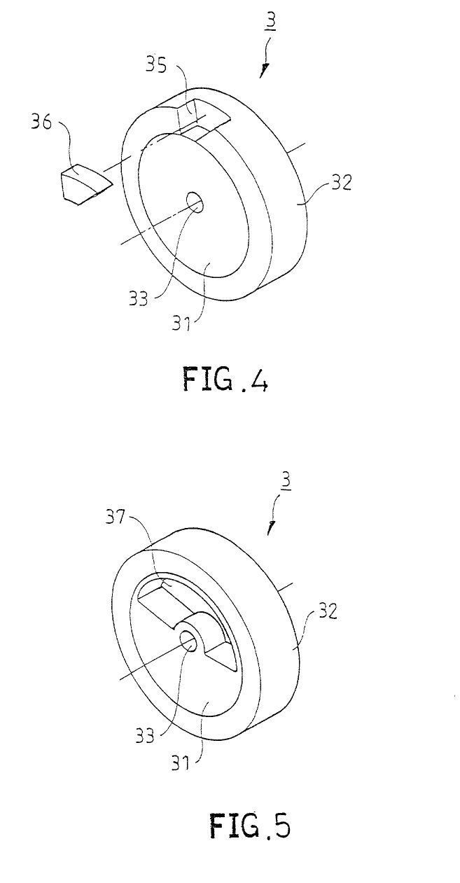

Referring to FIG. 4, in accordance with a third embodiment of the present invention, the recess 35 defined in the annular permanent magnet 32 on the periphery of the rotor 3 is embedded with an insert 36 having different material and specific gravity, so that the center of gravity and the center of rotation of the rotor 3 are not at the same central line. Thus, the rotation of the rotor 3 will form an unbalanced vibration.

Referring to FIGS. 5 and 6, in accordance with a fourth embodiment of the present invention, the bearing 31 of the rotor 3 is provided with a recess 37, so that the center of gravity and the center of rotation of the rotor 3 are not at the same central line. Thus, the rotation of the rotor 3 forms an unbalanced vibration.

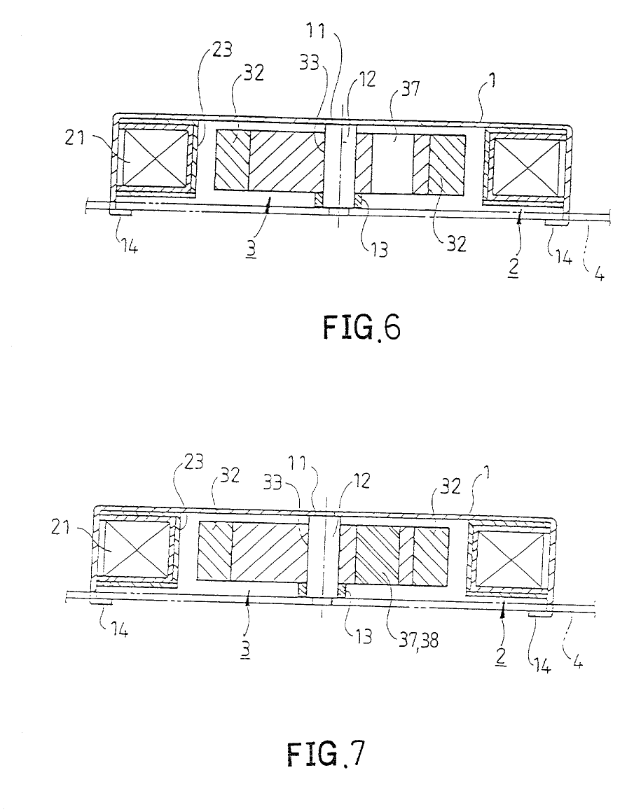

Referring to FIG. 7, in accordance with a fifth embodiment of the present invention, the recess 37 defined in the bearing 31 of the rotor 3 is embedded with an insert 38 having different material and specific gravity, so that the center of gravity and the center of rotation of the rotor 3 are not at the same central line. Thus, the rotation of the rotor 3 will form an unbalanced vibration.

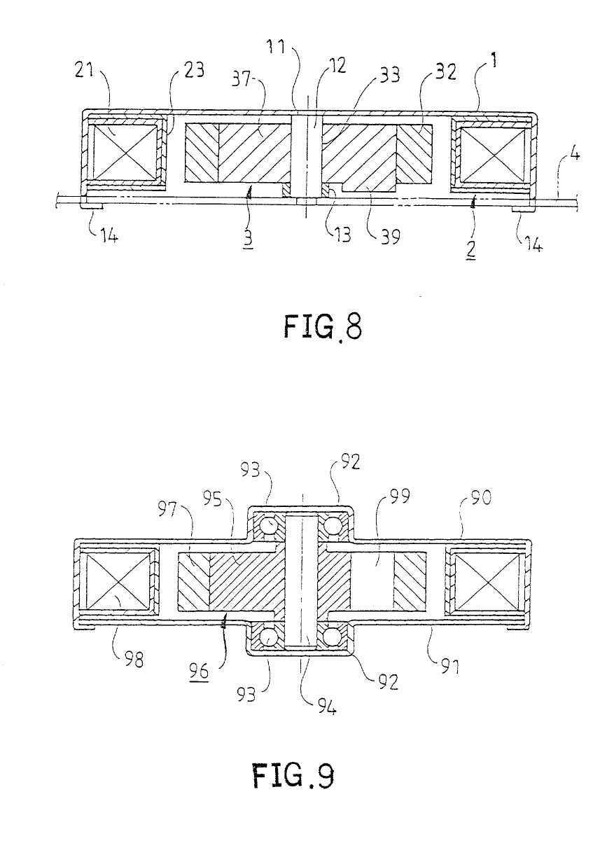

Referring to FIG. 8, in accordance with a sixth embodiment of the present invention, the bearing 31 of the rotor 3 is provided with a protruding block 39, so that the center of gravity and the center of rotation of the rotor 3 are not at the same central line. Thus, the rotation of the rotor 3 will form an unbalanced vibration.

Accordingly, in the miniature vibration motor structure in accordance with the present invention, the bearing and the rotor are integrally combined with each other. In addition, the bearing or the annular permanent magnet of the rotor may be provided with a protruding block, a recess or an insert, so that the center of gravity and the center of rotation of the rotor are not at the same central line. Thus, the rotation of the rotor will form an unbalanced vibration. Therefore, the entire construction of the vibration motor structure in accordance with the present invention is simple, and the volume and weight thereof may be largely shortened and reduced. Thus, the vibration motor of the present invention may satisfy the light, thin and small requirements of the communication equipment.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A miniature vibration motor structure, comprising:
a housing, having a hole for receiving and positioning one end of a shaft whose other end is positioned in a fixing plate;
a rotor, including a bearing, and an annular permanent magnet integrally formed on an outer periphery of the bearing, the bearing having a center defining a shaft hole for passage of the shaft, the bearing or the annular permanent magnet provided with a recess, so that a center of gravity and a center of rotation of the rotor are not in concert with each other;
a stator seat, wound with a coil, and having a power inlet for supplying an electric power into the stator seat, the stator seat having poles which may be induced with the permanent magnet of the rotor.

2. The miniature vibration motor structure as claimed in claim 1, wherein the recess defined in the bearing or the annular permanent magnet of the rotor is embedded with an insert whose material and specific gravity are different from that of the annular permanent magnet.

3. A miniature vibration motor structure, comprising:
a housing, having a hole for receiving and positioning one end of a shaft whose other end is positioned in a fixing plate;
a rotor, including a bearing, and an annular permanent magnet integrally formed on an outer periphery of the bearing, the bearing having a center defining a shaft hole for passage of the shaft, the bearing or the annular permanent magnet provided with a protruding block, so that a center of gravity and a center of rotation of the rotor are not in concert with each other;
a stator seat, wound with a coil, and having a power inlet for supplying an electric power into the stator seat, the stator seat having poles which may be induced with the permanent magnet of the rotor.
